(19) United States
(12) Patent Application Publication
(10) Pub. No.: US 2012/0170653 A1
(43) Pub. Date: Jul. 5, 2012

(54) BLOCK BASED SAMPLING CODING SYSTEMS

(75) Inventors: Krit Panusopone, San Diego, CA (US); Limin Wang, San Diego, CA (US)

(73) Assignee: GENERAL INSTRUMENT CORPORATION, Horsham, PA (US)

(21) Appl. No.: 12/982,488

(22) Filed: Dec. 30, 2010

(51) Int. Cl. H04N 11/02; H04N 7/12

(52) U.S. Cl. 375/240.16; 375/240.12; 375/E07.123; 375/E07.243

(57) ABSTRACT

A block based sampling (BBS) encoding system to process an incoming video signal into a compressed video bitstream. The BBS encoding system includes a processor to determine anchor blocks in a picture from the incoming video signal. The processor is also to encode the anchor blocks in the picture, and may also encode interpolated blocks in the picture using at least one of the encoded anchor blocks. There is also a block based sampling (BBS) decoding system to decode pictures from an incoming compressed video bitstream. The BBS decoding system includes a processor to receive the incoming compressed video bitstream including anchor block coding decisions about anchor blocks in a pattern in a picture, and decode the received anchor block coding decisions to form the anchor blocks in the pattern in the picture.

### BACKGROUND

ITU-T H.264/MPEG-4 Part 10 is the newest video coding standard. ITU-T H.264/MPEG-4 Part 10 is also referred to as MPEG-4 AVC (Advanced Video Coding). With the use of MPEG-4 AVC, bitrate savings of 50% or more over MPEG-2 are reported. For example, MPEG-4 AVC has been reported to give the same digital satellite television quality as comparable MPEG-2 implementations with less than half the bitrate, with the MPEG-2 implementations working at around 3.5 Mbit/s and MPEG-4 AVC at only 1.5 Mbit/s.

MPEG-4 AVC is able to encode pictures at lower bit rates than older standards while maintaining the same or better picture quality, but it is limited in its flexibility as to how it processes video data. Video compression systems commonly utilize block processing for many operations. In block processing, a block of neighboring pixels are grouped into a coding unit and in compression. This group of pixels is treated as one unit. In theory, a larger coding unit may be useful to take advantage of correlations among immediate neighboring pixels. Coding unit block sizes of 8×8 and 16×16 are employed in the known video compression standards, (e.g., MPEG-1, MPEG-2, and MPEG-4). In all of these standards an encoder utilizes a fixed processing order, such as a Raster scan processing order, for block processing. However, placing a limitation on the block processing order, such as in MPEG-4 AVC and in the older MPEG standards, can hamper video compression coding efficiency.

### BRIEF SUMMARY OF THE INVENTION

The illustrative embodiments demonstrate block based sampling (BBS) encoding and decoding. In BBS coding, there is increased flexibility in processing, such as block processing order. This flexibility in BBS coding may be utilized to provide for increases in video compression coding efficiency.

According to a first embodiment is a BBS encoding system to process an incoming video signal into a compressed video bitstream. The system includes a processor to determine anchor blocks in a picture from the incoming video signal, and encode the anchor blocks in the picture.

According to a second embodiment, is a block based sampling (BBS) encoding method processing an incoming video signal into a compressed video bitstream. The method includes determining anchor blocks in a picture from the incoming video signal, and encoding the anchor blocks in the picture.

According to a third embodiment is a non-transitory computer readable medium storing computer readable instructions that when executed by a computer system perform a block based sampling (BBS) encoding method to process an incoming video signal into a compressed video bitstream. The method includes determining anchor blocks in a picture from the incoming video signal, and encoding the anchor blocks in the picture.

According to a fourth embodiment is a block based sampling (BBS) decoding system to decode pictures from an incoming compressed video bitstream. The BBS decoding system includes a processor to receive the incoming compressed video bitstream including anchor block coding decisions about anchor blocks in a pattern in a picture, and decode the received anchor block coding decisions to form the anchor blocks in the pattern in the picture.

According to a fifth embodiment is a block based sampling (BBS) decoding method to decode pictures from an incoming compressed video bitstream. The method includes receiving the incoming compressed video bitstream including anchor block coding decisions about coded anchor blocks in a pattern in a picture and decoding the received anchor block coding decisions to form the anchor blocks in the pattern in the picture.

According to a sixth embodiment is a non-transitory computer readable medium storing computer readable instructions that when executed by a computer system perform a block based sampling (BBS) decoding method to decode pictures from an incoming compressed video bitstream. The method includes receiving the incoming compressed video bitstream including anchor block coding decisions about coded anchor blocks in a pattern in a picture and decoding the received anchor block coding decisions to form the anchor blocks in the pattern in the picture.

### BRIEF DESCRIPTION OF DRAWINGS

Embodiments are described in detail in the following description with reference to the following figures:

FIG. 1A is a BBS example illustrating a largest coding tree block (LCTB) coding of a quad tree (QT) block structure;

FIG. 1B is a BBS coding example illustrating a Raster scan coding order;

FIG. 1C is a BBS coding example illustrating a first anchor block pattern coding order, according to an embodiment;

FIG. 1D is a BBS coding example illustrating a second anchor block pattern coding order, according to an embodiment;

FIG. 1E is a BBS coding example illustrating a third anchor block pattern coding order, according to an embodiment;

FIG. 1F is a BBS coding example demonstrating calculations of a predictive motion vector (PMV) for an anchor block in the first selected anchor block pattern coding order of FIG. 2B, according to an embodiment;

FIG. 1G is a BBS coding example demonstrating an inter mode skip mode calculation to derive a motion vector for an interpolated block, according to an embodiment;

FIG. 1H is a BBS coding example demonstrating an inter mode interpolative mode calculation to derive a motion vector for an interpolated block, according to an embodiment;

FIG. 1I is a BBS coding example demonstrating an intra mode interpolative mode calculation to derive a motion vector for an interpolated block, according to an embodiment;

FIG. 2 is a block system diagram illustrating an compressed video bitstream 202 between a BBS coding system 210 and a BBS decoding system 240, according to an embodiment;

FIG. 3A is a flowchart illustrating a BBS coding method 300, according to an embodiment;

FIG. 3B is a flowchart illustrating a BBS decoding method 350, according to an embodiment; and

FIG. 4 is a block system diagram illustrating a computer system configured to provide a hardware platform for the BBS coding system 210 and the BBS decoding system 240 shown in FIG. 2, according to different embodiments.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent however, to one of ordinary skill in the art, that the embodiments may be practiced without limitation to these specific details. In some instances, well known methods and structures have not been described in detail so as not to unnecessarily obscure the embodiments. Furthermore, different embodiments are described below. The embodiments may be used or performed together in different combinations.

### 1. Definitions

The term block, as used herein, refers to a block of pixels of variable size in a picture.

The term partition, as used herein, refers to a portion of a block.

The term anchor block, as used herein, refers to a block within a picture that is encoded in pass one of a BBS encoding process. An anchor block may be used as a predictive reference in BBS encoding of other blocks in the picture. The degree of BBS encoding associated with an anchor block is analogous with the degree of coding associated with an I-frame or a P-frame in MPEG-4 AVC. However, an anchor block is merely a block of pixels in a picture and is not as large as a complete picture or frame.

The term interpolated block, as used herein, refers to a block that is encoded in pass two of a BBS encoding process. BBS encoding for an interpolated block relies upon the encoding associated with at least one neighboring anchor block in the picture which is used as a predictive reference for the BBS encoding of the interpolated block in the picture. The degree of BBS encoding associated with an interpolated block is analogous with the degree of coding associated with a B-frame or a P-frame in MPEG-4 AVC. However, an interpolated block is a block of pixels in a picture and is not as large as a complete picture or frame.

The term motion search window, as used herein, refers to a part of a picture being encoded. The motion search window defines a variable window of pixels, such as n×n or m×n, in a reference picture for inter prediction. The motion search window uses a current block to find a best match in a reference picture. The motion search window is used to scan the current picture for all the candidate motion vectors in the search window. The total search window is usually (M+1)−(M−1), but may be varied. Each scanned position using the motion search window will produce a candidate motion vector.

The term candidate motion vector, as used herein, refers to a geometrical offset of the two coordinates in a scanned area.

The term template, as used herein refers to a template utilized to synthesize an interpolated block or part of an interpolated block. For example, an template can include portions of its adjacent anchor blocks.

The term template matching information, as used herein refers to the reconstructed pixels inside interpolated block template. The template matching information should be available at both encoder and decoder.

### 2. BBS Coding Modes

Block based sampling (BBS) coding adds greater flexibility to video compression coding compared with MPEG-4 AVC and previous MPEG standards. According to an embodiment, BBS coding is more flexible by allowing blocks to be coded in any processing order. As described in greater detail below, in BBS coding, one or more anchor blocks in a picture are encoded. One or more interpolated blocks may be encoded utilizing information from encoding one or more anchor blocks. An anchor block may be located in various locations, such as any location in a picture including the interpolated block. Anchor blocks and interpolated blocks may be located without limitation with respect to each other. Furthermore, only at least one anchor block need be encoded before an interpolated block is encoded using information associated with the anchor block. This flexibility in BBS coding may be utilized to provide for increases in video compression coding efficiency.

In BBS coding, the blocks may be of variable sizes and/or shape. This includes using a quad tree (QT) block structure. QT block structures utilize a block terminology including coding unit (CU), partition unit (PU), and transform unit (TU), instead of the terms macroblock and partition as in the MPEG-4 AVC standard.

QT block structures, when used in BBS coding according to an embodiment, provide an efficient way to represent a variable size block structure because it allows relatively flexible partitioning with low overhead. QT block structures are simple; a parent node (square block) may be split into four child nodes, each of which has a quarter size of their parent. Each child node may then be split repeatedly until the process reaches a stop condition. In a BBS video compression context, QT block structures represent a collection of non-overlapping coding blocks that provides the lowest coding cost over a given area and shape. The position of each coding block is determined by its position in the QT. Although larger coding block areas generally provide better coding efficiency, in BBS coding a QT having a limited maximum size may be utilized (i.e., a largest coding tree block, LCTB) in order to limit the complexity of the encoding process.

BBS coding may be applied at a limited maximum size LCTB. Moreover BBS encoding may be applied within a LCTB. An encoding processing order for 4 children nodes may be from a top left node, to a top right node, to a bottom left node, and then a bottom right note. According to the embodiment, the BBS encoding process repeats for each QT layer.

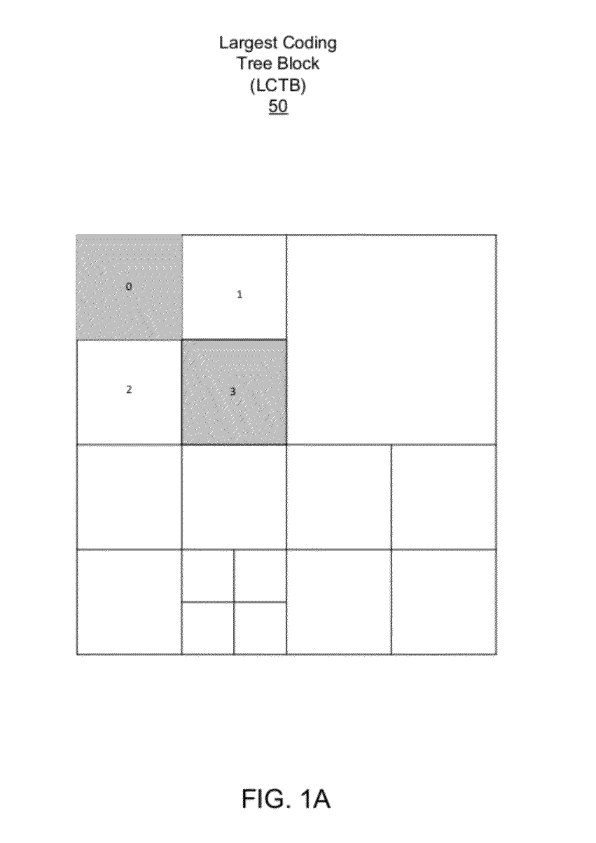

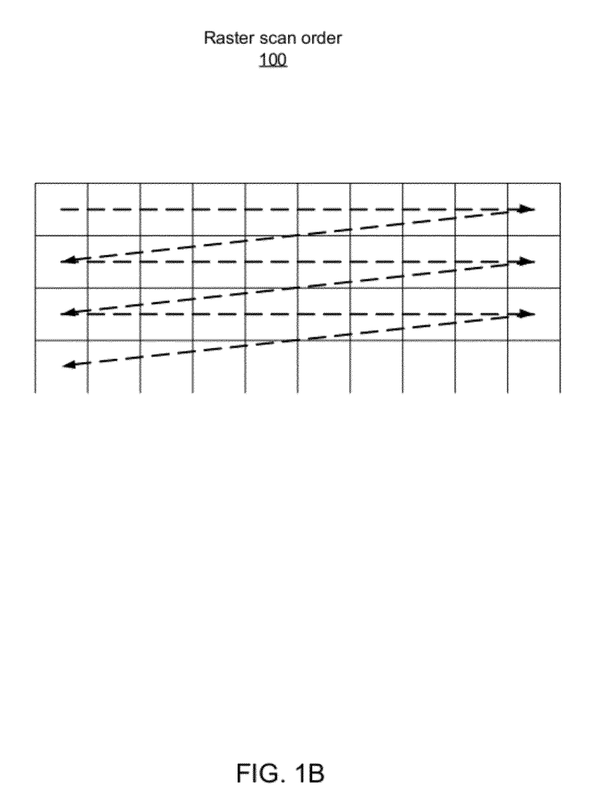

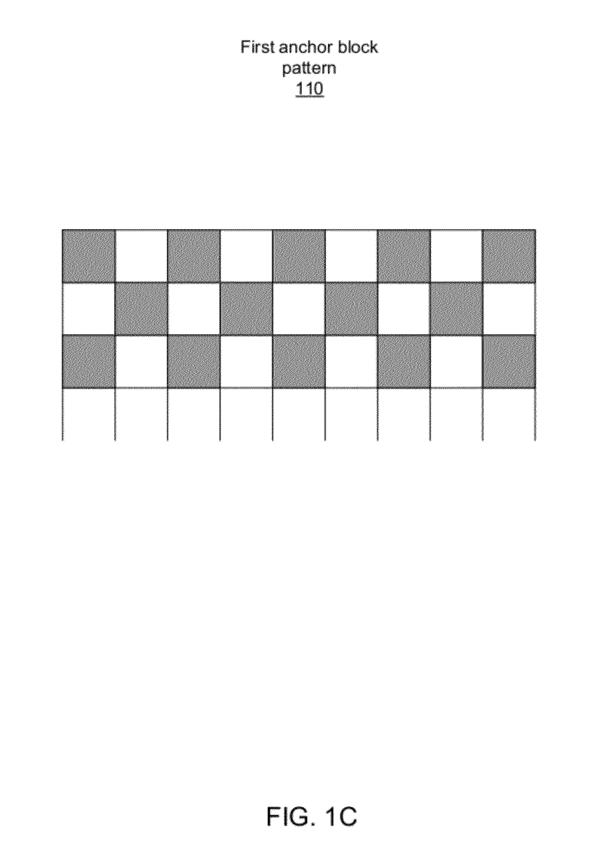

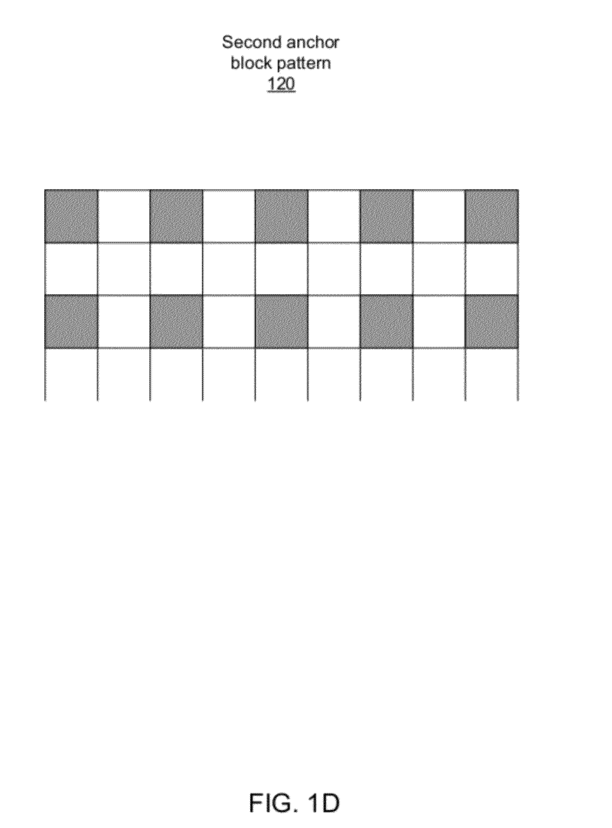

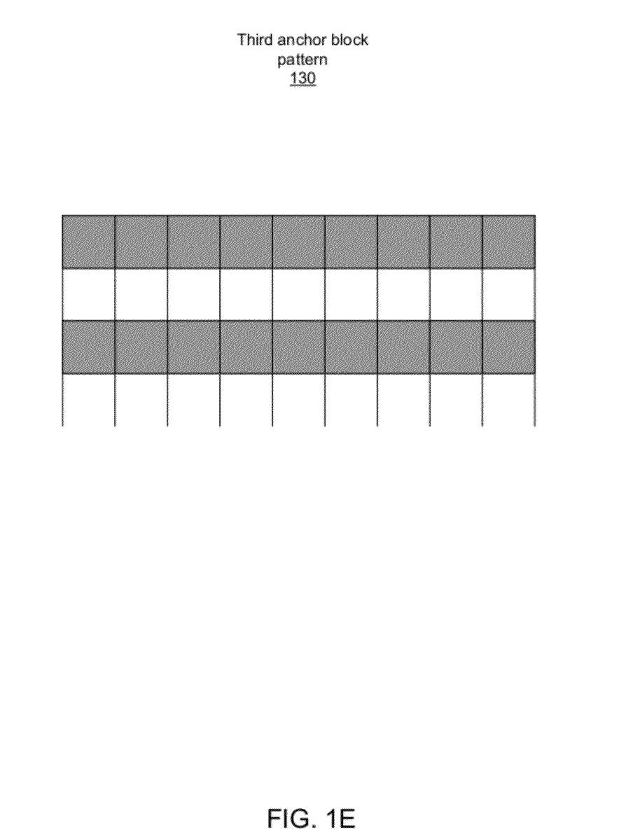

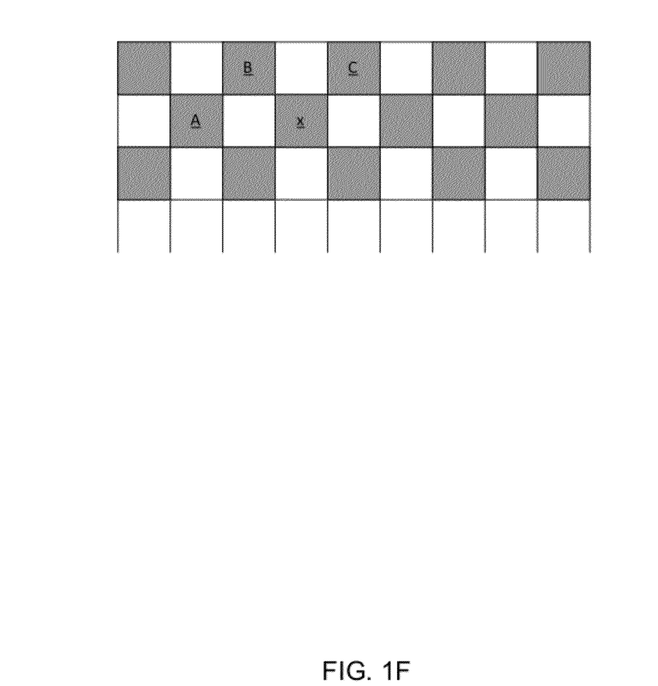

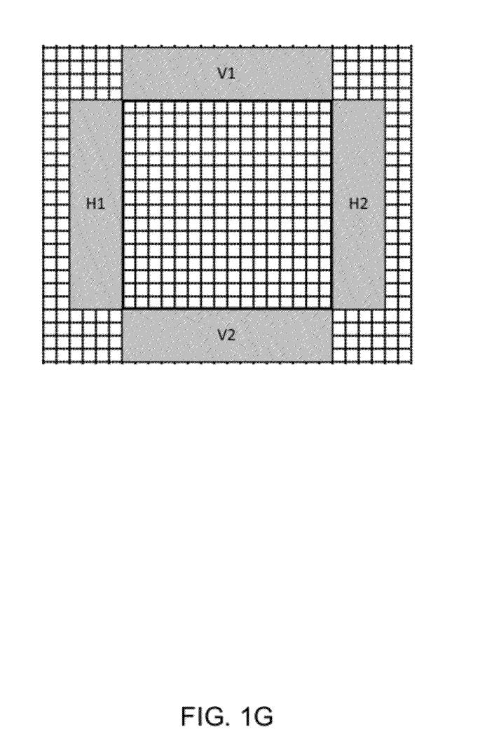

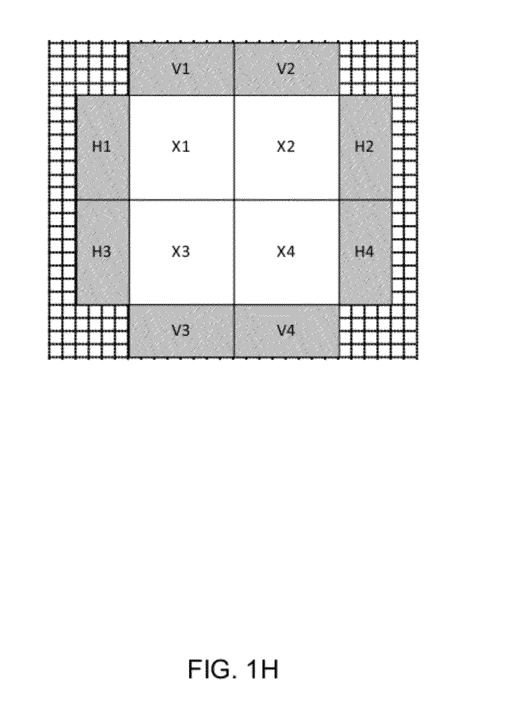

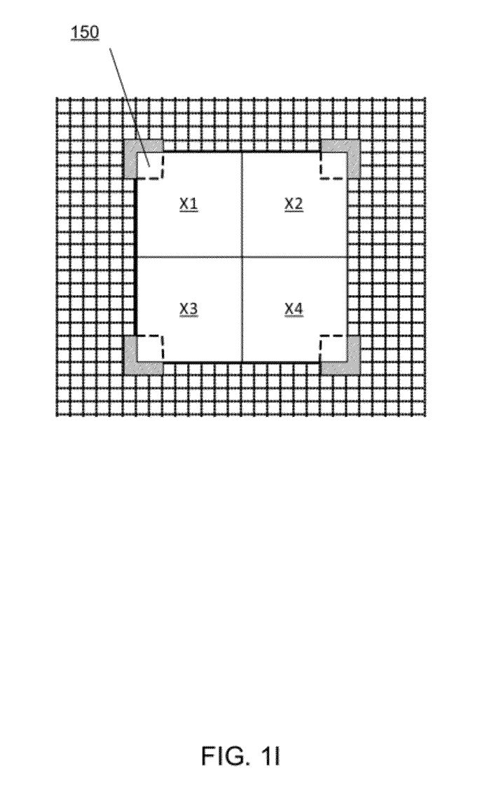

In BBS coding, many different coding patterns can be employed for anchor block and interpolated block. In one embodiment, anchor block processing order of top left and bottom right and interpolated block processing order of top right and bottom left can be used. For example, FIG. 1A shows an example of BBS coding utilizing LCTB which splits into multiple CU. For layer 1 nodes (top left quadrant), there are 4 children block nodes numbered as node 0, node 1, node 2, and node 3. Shaded block nodes 0 and 3 are coded first as anchor block while block nodes 1 and 2 are subsequently coded as interpolated block.

According to an embodiment, a video codec may process a picture for BBS coding on a block by block basis in a Raster scan order, as demonstrated in FIG. 1B. The Raster scan order may be utilized so that correlations with immediately neighboring blocks to the left and top can be exploited in the coding process. The Raster scan order may be practical from an implementation perspective because it accesses memory to process video data in a consecutive region. However, as disclosed below, with respect to BBS coding, the Raster scan order does not always provide immediate neighboring blocks with correlations providing the highest efficiency in coding a picture on a block by block basis. Higher coding efficiency may be obtained when a non-consecutive BBS coding processing order is utilized.

In the BBS coding system, according to an embodiment, blocks, such as MB sized blocks, within a picture are classified into two general types, anchor blocks and interpolated blocks. The anchor blocks within a picture are coded first either in intra mode or inter mode, both of which are described in greater detail below. Then the interpolated blocks are coded utilizing the information obtained in coding the anchor blocks. This hierarchical sequence utilized in BBS coding at the block level in a picture achieves higher overall coding efficiency by enabling increased predictability in coding the interpolated blocks.

Higher coding efficiency is obtained when a non-consecutive processing order is used. FIGS. 1C-1E show various patterns wherein the anchor blocks, shown as shaded blocks, are processed in the first pass and the interpolated blocks, shown as non-shaded blocks, are processed on the second pass. The BBS coding methodology may be extended to BBS coding with more than two passes following the hierarchy of coding anchor blocks in prior passes. BBS coding takes advantage of any correlations in pixel properties among neighboring blocks within a picture. Hence, a block may be more accurately predicted and/or interpolated from using the neighbor information from neighbor blocks within the picture.

There are various modes in BBS coding which may be used to encode the interpolated blocks in the second pass using information from the anchor blocks from the first pass. The encoding method utilized may lower the amount of overhead required in terms of bit stream size used in communicating coding information from the coder to the decoder. Also, the encoding method utilized may provide an improved estimation of the coding information associated with the interpolated blocks in the second pass. One way to accomplish the interpolated block encoding process is through template matching wherein given a current block, its template may be formed from its neighboring block pixel information.

Template matching has been widely used in texture synthesis and error concealment to synthesize missing data. Template matching takes advantage of a correlation in properties between a synthesizing block and its template. If this correlation exists or is substantial, template matching can use a target block associated with the template to synthesize a best matched template for the synthesizing block. Template matching methodologies in video coding applications are also described in U.S. Pat. No. 6,236,683 and U.S. Published Patent Application No. 2009/0180538, both of which are herein incorporated by reference in their entireties.

BBS coding includes two primary modes, known respectively as inter mode and intra mode. These two primary modes may each operate in a secondary mode, such as interpolative mode, skip mode or explicit mode described in more detail below.

In inter mode BBS coding, the coder may not transmit a motion vector explicitly. Instead, the decoder may recover the same motion vector by performing a template matching process with its available neighboring block information. The template matching approach uses a template with the available information at the decoder. There is also an explicit inter mode in which a motion vector may be sent explicitly with respect to a BBS encoded anchor block or a BBS encoded interpolated block.

In intra mode BBS coding, the encoder may not transmit the prediction direction information explicitly. The decoder may recover the same texture by performing the template matching process with its available neighbor blocks information and adding that texture to a received residual block.

The template matching based approach is well suited for the interpolation process in BBS coding since BBS coding is able to increase the correlation of template and the current block. In BBS coding, the coding process may begin processing a second pass of blocks after completing the first pass blocks in the row underneath.

The following illustrative examples shown with respect to FIG. 1F to demonstrate BBS coding in different modes with template matching using the same processing order shown in FIG. 1C. In this processing order, there are equal numbers of anchor blocks and interpolated anchor blocks. The anchor blocks interleave with the interpolated blocks evenly and each interpolated block is surrounded by four anchor blocks, one above, one below and one to each of the left and right directions.

In BBS coding, an anchor block may be encoded in either intra mode or inter mode.

FIG. 1F demonstrates an aspect of BBS coding. When coding an anchor block in intra mode, a four directional prediction mode may be used for a 16×16 partition and nine directional prediction modes may be used for a 4×4 partition. One aspect of the BBS coding in intra mode is in the predictor derivation. In FIG. 1F, boundary pixels of three nearer neighboring blocks labeled A, B and C are used to derive a predictor block, X. These three different locations reflect neighboring block data availability with respect to predictor block X at the decoder for decoding. In other embodiments, other neighboring blocks may be utilized, added or subtracted to obtain different sources of neighbor block information.

When coding an anchor block in inter mode, multiple partition sizes and multiple reference pictures may be utilized. An aspect of the inter mode BBS coding is in the calculation of the predictive motion vector (PMV). The different locations of the same three neighbors A, B and C as shown in FIG. 1F may be utilized. These three different locations reflect the data availability at the decoder for decoding in inter mode. In other embodiments, other neighboring blocks may be utilized, added or subtracted to obtain different sources of neighbor block information.

Interpolated blocks may also be encoded either in intra mode or inter mode.

For interpolated blocks encoded in inter mode, the BBS encoding focuses on reducing bit stream size required for transmitting motion vector information while maintaining motion compensation quality. The BBS coding method codes the anchor blocks first to establish neighbor information to form a stronger predictor for the interpolated block. The interpolated block may then be predictive coded without transmitting motion vectors in the bit stream.

An interpolated block in inter mode may be further divided into partitions, each having a separate motion vector. The motion vector for a current partition is determined by searching through a motion search window for a candidate that gives the lowest matching cost with a specific template formed for the partition. Since the template for the partition and the motion search window are available at the decoding side, the same motion vector may be generated at the decoder as is generated at the encoder.

As noted above, there are secondary mode types to the primary inter mode which may be utilized in BBS encoding for interpolated blocks. These secondary modes types are skip mode, interpolative mode and explicit mode.

FIG. 1G demonstrates another aspect of BBS coding for interpolated block. The skip inter mode may use a partition, such as a 16×16 partition. No bits are sent for prediction residuals and motion vectors in the bit stream. The decoder derives the motion vectors by performing a motion search for a specific template over a window with a specified window size, such as +/−m pixels, m×m pixels, m×n pixels and the like, around the PMV. For any given partition of an interpolated block, a possible template can be formed using the pixels of its boundary anchor blocks, such as shown in FIG. 1G using boundary pixel groups V1, V2, H1 and H2.

FIG. 1H demonstrates another aspect of BBS coding for interpolative block. In the interpolative inter mode, a partition, such as an 8×8 partition is used, and its motion vectors are not sent in the bit stream. The decoder derives motion vectors by performing a search for a specific template over a specified window of, for example, +/−n pixels around the PMV. The template for interpolative mode can be formed using the pixels over the boundaries to each partition as shown in FIG. 1H, using boundary pixel groups, such as boundary pixel groups V1 and H1, for partition X1. For a 16×16 partition in the interpolative mode, the template can be formed using the pixels over the boundaries, as shown in FIG. 1G.

In the explicit inter mode, the BBS coding processes are similar to those used in MPEG-4 AVC and the differences between motion vectors and their predictor motion vectors (PMV) are sent explicitly in the bit stream. Given a partition of an interpolated block, a PMV is calculated based on the motion vectors associated with the neighboring blocks. The PMV(s) for interpolated blocks are often different from the PMV(s) defined in MPEG4 AVC since their available coded neighbor blocks are different.

In the skip inter mode, a PMV is set according to a PMV direction so that the PMV captures a global motion vector direction accurately. Horizontal motion vectors, left and right, and vertical motion vectors, top and bottom, may be used to compute the PMV direction. The global motion vector direction may be calculated according to equation 1. In the equation 1 below, the term direction is the calculated PMV direction, based on both a horizontal component termed as horizontal and a vertical component termed as vertical in the equation 1 below. The horizontal component and vertical components may be measured based on the absolute values of the x and y motion vectors MVx and MVy within the parameters defined below with respect to the equation 1.

$$\begin{matrix}Equation 1 & \\ PMV = \{ \begin{matrix}PMV\_horizontal ; & Hdiff \leq Vdiff \\ PMV\_vertical ; & Vdiff < Hdiff\end{matrix} \\ Where \\ Hdiff = \vert {MV}_{x} ( x - 1 , y ) - {MV}_{x} ( x + 1 , y ) \vert + \vert {MV}_{y} ( x - 1 , y ) - {MV}_{y} ( x + 1 , y ) \vert \\ Vdiff = \vert {MV}_{x} ( x , y - 1 ) - {MV}_{x} ( x , y + 1 ) \vert + \vert {MV}_{y} ( x , y - 1 ) - {MV}_{y} ( x , y + 1 ) \vert & ( 1 )\end{matrix}$$

Thus, in utilizing equation 1, the direction of the PMV is the average of either the horizontal motion vectors or the vertical motion vectors.

The PMV is derived differently in interpolative inter mode as each partition has up to four neighboring anchor blocks. Partitions such as 8×8 or other sizes may be used. A partition of neighboring block is in the horizontal direction and another partition of neighboring block is in the vertical direction, such as for the X1 partition shown in FIG. 1H. The PMV for X1 is set as equal to one of the two motion vectors of its neighbor blocks, H1 and V1.

In the explicit inter mode, the PMV may be set according to the partition type Variable block sizes may be utilized as partitions. The partitions may be square or rectangular, such as 16×8 and 8×16 partitions. The number of anchor neighbors may vary. For a square 16×16 partition, the PMV may be calculated in the same way as the PMV is calculated in the skip mode. For an 8×8 partition, the PMV may be computed in the same way as the PMV is calculated in the interpolated mode. For 16×8 and 8×16 partitions, the same PMV direction may be followed as the associated neighbor. A left 8×16 partition may use the motion vector of its left neighbor as its PMV. A right 8×16 partition may use the motion vector of its right neighbor as its PMV, such as in FIG. 1H, the right 8×16 partition X2:X4 may use the motion vector of the top and the bottom neighbors associated with V2 and V4. A top 16×8 partition may use the motion vector of its left and right neighbors as its PMV. And a bottom 16×8 partition may use the motion vector of its left and right neighbors as its PMV. The PMV for smaller partitions of a block (8×4, 4×8 and 4×4) may follow the same methodology as the larger partitions of the block.

For intra mode coding of interpolated blocks, BBS coding focuses on reducing the bit stream size used for transmitting texture information while at the same time maintaining prediction accuracy. However, the intra mode in BBS coding method may achieve this by coding multiple anchor blocks first to establish neighbor information. The use of multiple anchor blocks enables calculation of a stronger predictor for the interpolated block. The interpolated block is thus more accurately predicted resulting in smaller texture residuals (e.g., differences between corresponding blocks of different pictures) needing to be coded for the interpolated block.

BBS coding improves template matching efficiency by encoding anchor blocks to provide neighbor information from a plurality of directions, such as two directions, more preferably three directions and still more preferably four directions (i.e., top, bottom, left and right), with the possibility of even more anchor blocks being used.

A predictor may be determined iteratively by searching through a motion search window for a candidate motion vector that gives the lowest matching cost. To find the lowest matching cost, a metric is first defined, such as the sum of the absolute difference. Then the candidate motion vector with the closes match to the metric is the lowest matching cost candidate with a template of a current block. Since the template of the current partition and the search window are available at the decoder side, the same predictor may be generated at both the coder and the decoder.

Two secondary modes may be used within the primary intra mode are used for coding interpolated blocks. One is the interpolative intra mode. The other is the explicit intra mode.

FIG. 1I demonstrates another aspect of BBS coding. In the interpolative intra mode, each 8×8 partition may be coded iteratively. The decoder may establish a predictor by performing a search of, for example, m×n pixels around the current partition. As shown in FIG. 1I, a one pixel wide template is formed using two boundaries adjacent to the available neighbor blocks, such as the shown with respect to target block 150. In FIG. 1H, target block 150 is a three pixels wide area associated with an 8×8 partition X1. Target block 150 shown in FIG. 1H is a 2×2 target block having a template which is 1 pixel wide. The interpolative intra mode codes each 8×8 partition separately and each 8×8 block has its own template.

In the explicit intra mode, coding processes and options similar to those in MPEG-4 AVC are utilized and the prediction direction is sent explicitly in the bit stream.

### 3. BBS Encoding and Decoding Systems

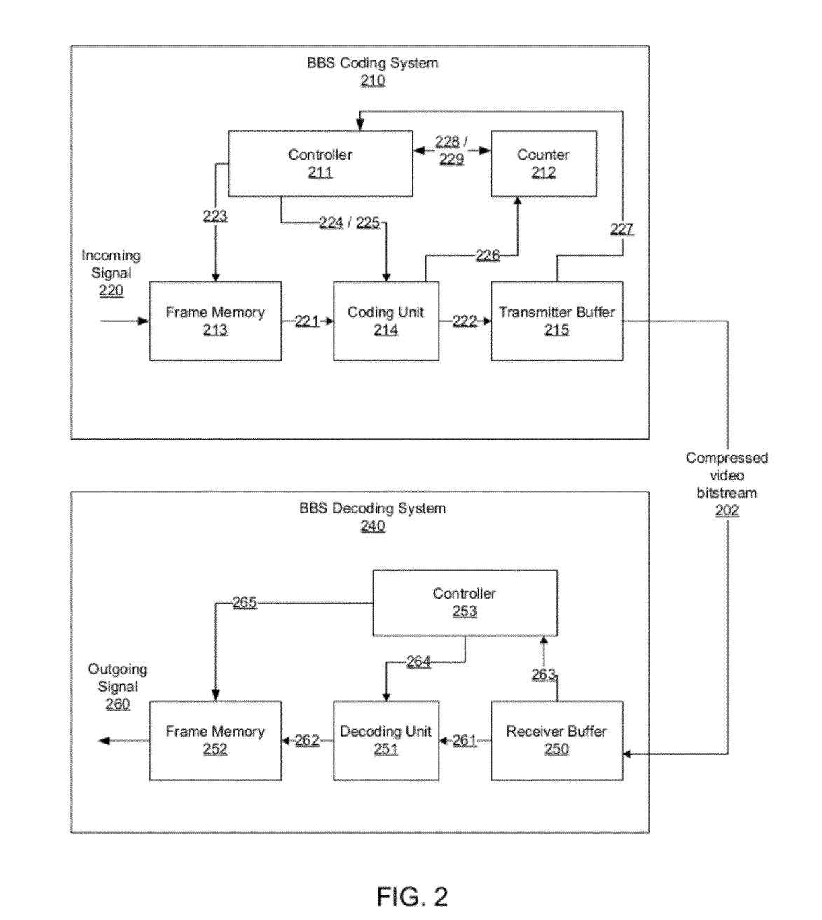

FIG. 2 illustrates a BBS coding system 210 and a BBS decoding system 240, according to an embodiment. The BBS coding system 210 delivers an MPEG-4 transport stream 202 to a BBS decoding system 240, according to an embodiment. The BBS coding system 210 includes a controller 211, a counter 212, a frame memory 213, an encoding unit 214 and a transmitter buffer 215. The BBS decoding system 240 includes a receiver buffer 250, a decoding unit 251, a frame memory 252 and a controller 253. The BBS encoding system 210 and the BBS decoding system 240 are coupled to each other via a transmission path used to transmit the transport stream 202. The transport stream is not limited to any specific video compression standard. The controller 211 of the BBS coding system 210 controls the amount of data to be transmitted on the basis of the capacity of the receiver buffer 250 and may include other parameters such as the amount of data per a unit of time. The controller 211 controls the encoding unit 214, to prevent the occurrence of a failure of a received signal decoding operation of the BBS decoding system 240. The controller 211 may include, for example, a microcomputer having a processor, a random access memory and a read only memory.

An incoming signal 220 supplied from, for example, a content provider. The incoming signal 220 may include video signal data. The video data may be passed into pictures and/or frames, which are input to the frame memory 213. The frame memory 213 has a first area used for storing the incoming signal 220 and a second area used for reading out the stored signal and outputting it to the encoding unit 214. The controller 211 outputs an area switching control signal 223 to the frame memory 213. The area switching control signal 223 indicates whether the first area or the second area is to be used.

The controller 211 outputs an encoding control signal 224 to the coding unit 214. The coding control signal 224 causes the coding unit 214 to start the coding operation. In response to the coding control signal 224, the coding unit 214 starts to read out the video signal to a high-efficiency coding process, such as a BBS coding process to code the pictures or frames to form coded units, which form an encoded video bitstream. An encoded unit may be a picture, a slice, an MB, etc.

A coded video signal 222 with the BBS coded units is stored in the transmitter buffer 215 and the information amount counter 212 is incremented to indicate the amount of data in the transmitted buffer 215. As data is retrieved and removed from the buffer, the counter 212 is decremented to reflect the amount of data in the buffer. The occupied area information signal 226 is transmitted to the counter 212 to indicate whether data from the coding unit 214 has been added or removed from the transmitted buffer 215 so the counter 212 can be incremented or decremented. The controller 211 controls the production of coded units produced by the coding unit 214 on the basis of the occupied area information 226 communicated in order to prevent an overflow or underflow from taking place in the transmitter buffer 215.

The information amount counter 212 is reset in response to a preset signal 228 generated and output by the controller 211. After the information counter 212 is reset, it counts data output by the coding unit 214 and obtains the amount of information which has been generated. Then, the information amount counter 212 supplies the controller 211 with an information amount signal 229 representative of the obtained amount of information. The controller 211 controls the coding unit 214 so that there is no overflow at the transmitter buffer 215.

The receiver buffer 250 of the BBS decoding system 240 may temporarily store the coded data received from the BBS coding system 210 via the MPEG-4 transport stream 202. The BBS decoding system 240 counts the number of coded units of the received data, and outputs a picture or frame number signal 263 which is applied to the controller 253. The controller 253 supervises the counted number of frames at a predetermined interval, for instance, each time the decoding unit 251 completes the BBS decoding operation.

When the picture/frame number signal 263 indicates the receiver buffer 250 is at a predetermined capacity, the controller 253 outputs a decoding start signal 264 to the decoding unit 251. When the frame number signal 263 indicates the receiver buffer 250 is at less than a predetermined capacity, the controller 253 waits for the occurrence of the situation in which the counted number of pictures/frames becomes equal to the predetermined amount. When the picture/frame number signal 263 indicates the receiver buffer 250 is at the predetermined capacity, the controller 253 outputs the decoding start signal 264. The coded units may be decoded in a monotonic order (i.e., increasing or decreasing) based on a presentation time stamp (PTS) in a header of the BBS coded units.

In response to the decoding start signal 264, the decoding unit 251 decodes data amounting to one picture/frame from the receiver buffer 250, and outputs the data. The decoding unit 251 writes a decoded signal 262 into the frame memory 252. The frame memory 252 has a first area into which the decoded signal is written, and a second area used for reading out the decoded data and outputting it to a monitor or the like.

### 4. Methods

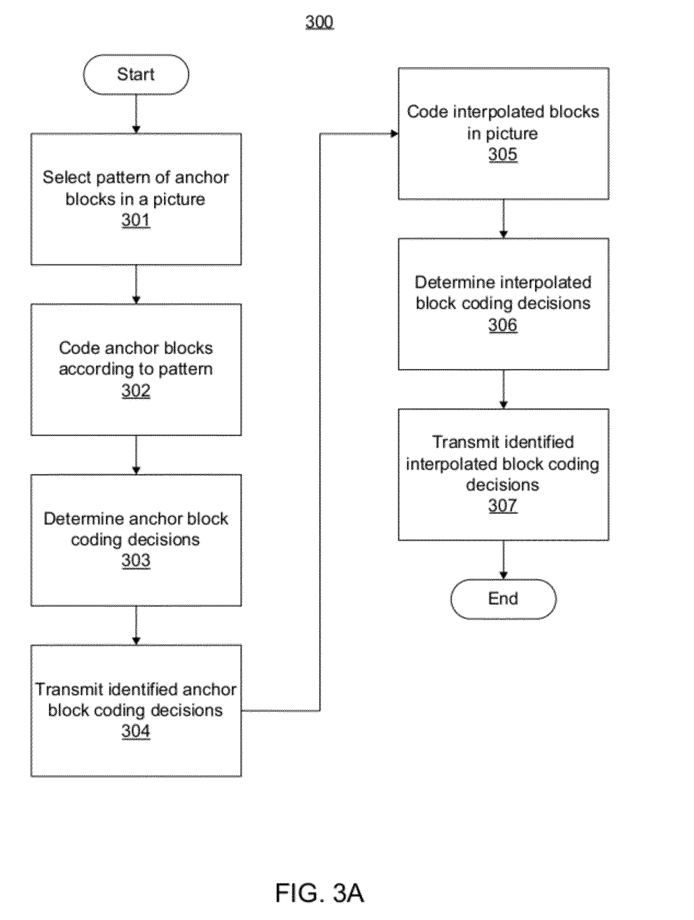

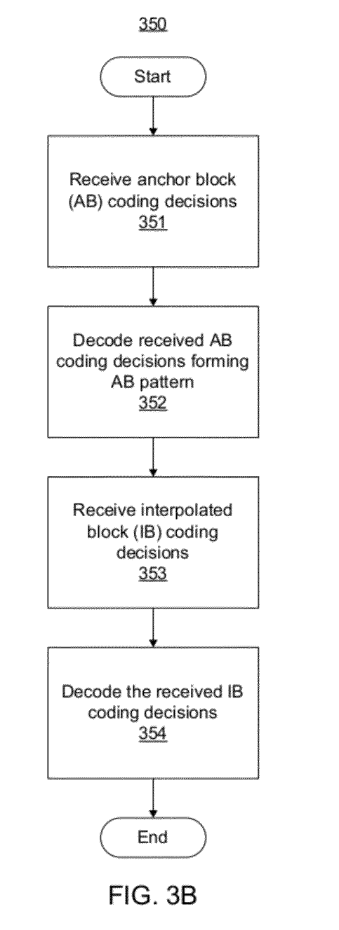

FIG. 3A illustrates a BBS coding method 300 according to an embodiment. The method is described with respect to the BBS coding system 210 shown in FIG. 2 by way of example and not limitation. The method may be performed in other systems. The steps of the method may be performed in a different sequence or one or more may be omitted.

At step 301, the coding unit 214 in the BBS coding system 210 selects a pattern of anchor blocks in a picture. The pattern may be varied as illustrated in FIGS. 1B-1D.

At step 302, the coding unit 214 codes the anchor blocks in the pattern in the picture. The anchor blocks may be BBS coded using either an inter mode or an intra mode.

At step 303, the coding unit 214 determines anchor block coding decisions and identifies anchor block coding decision to be transmitted in the compressed video bitstream 202. The transmitted anchor block coding decisions may include template matching information and anchor block motion vector information and other meta data associated with the video compression of the incoming signal data 220. The template matching information may be used in the in the BBS decoding process to decode the interpolated block coding decisions to form the decoded interpolated blocks. Similarly, the anchor block motion vector information may be used in the BBS decoding process to decode the interpolated block coding decisions to form the decoded interpolated blocks.

At step 304, the transmitter buffer 215 transmits the identified anchor block coding decisions, which may include the anchor block motion vector information. The coding decisions may be included with BBS coded units sent via the compressed video bitstream 202.

At step 305, the coding unit 214 codes the interpolated blocks in the picture using at least one of the template matching information and the anchor block motion vector information. The interpolated blocks may be coded in an inter mode or an intra mode as a primary mode. For any specific block, different secondary modes may be utilized as described above, although only one code mode may be used for each specific block.

At step 306, the coding unit 214 determines interpolated block coding decisions. The interpolated block coding decisions identified for transmission in the compressed video bitstream may exclude motion vector information.

At step 307, the transmitter buffer 215 transmits selected interpolated block coding decisions, including the template matching information. The coding decisions may be included with BBS coded units sent via the compressed video bitstream 202. The selected interpolated block coding decisions to be transmitted are dependent upon which BBS coding mode is used to encode interpolated blocks. For instance, if a BBS coding inter mode is used, then motion vector information which may be associated with the coded interpolated blocks is not included with the selected interpolated block coding decisions, thus reducing the amount of information associated with interpolated blocks sent via the compressed video bitstream 202, or any other stream which may be utilized.

FIG. 3B illustrates a BBS decoding method 350 according to an embodiment, for a BBS decoding system processing BBS coded units including BBS coding decisions. The method is described with respect to the BBS decoding system 240 shown in FIG. 2 by way of example and not limitation. The method may be performed in other systems. The steps of the method may be performed in a different sequence or one or more may be omitted.

At step 351, the receiver buffer 250 in the BBS decoding system 240 receives anchor block coding decisions including template matching information and anchor block motion vector information. The coding decisions may be included with BBS coded units received via the compressed video bitstream 202.

At step 352, the decoding unit 251 decodes the received anchor block coding decisions to form anchor blocks in a pattern of the anchor blocks in a picture.

At step 353, the receiver buffer 250 in the BBS decoding system 240 receives interpolated block coding decisions including template matching information. The template matching information is the information required to decode the interpolated blocks which is used in conjunction with the neighboring information associated with previously decoded anchor blocks, such as the anchor block motion vectors, texture information, etc. The interpolated block coding decisions may be included with BBS coded units sent via the compressed video bitstream 202 or any packetized video stream.

At step 354, the decoding unit 251 then decodes the received interpolated block coding decisions to form interpolated blocks in the picture using the template matching information and/or the anchor block motion vector information associated with the anchor blocks in the pattern. The fully decoded pictures may include the anchor blocks and the interpolated blocks. These may be transmitted to users via the outgoing signal 260 from the BBS decoding system 240.

### 5. Computer System for Executing Software

One or more of the steps and functions described herein and one or more of the components of the systems described herein may be implemented as computer code comprising computer readable instructions stored on a computer readable storage device, such as memory or another type of storage device. The computer code is executed on a computer system, such as computer system 400 described below by a processor, such as an application-specific integrated circuit (ASIC), or other type of circuit. The code may exist as software programs comprised of program instructions in source code, object code, executable code or other formats.

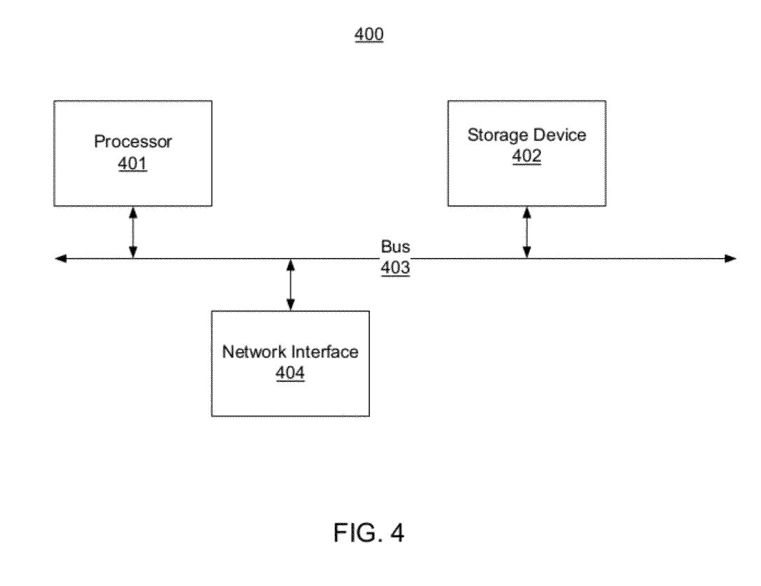

FIG. 4 shows a computer system 400 which may be used as a hardware platform for the BBS coding system 210 or the BBS decoding system 240. Computer system 400 may be used as a platform for executing one or more of the steps, methods, and functions described herein that may be embodied as software stored on one or more computer readable storage devices, which are hardware storage devices.

The computer system 400 includes a processor 401, or processing circuitry, that may implement or execute software instructions performing some or all of the methods, functions and other steps described herein. Commands and data from processor 401 are communicated over a communication bus 403. Computer system 400 also includes a computer readable storage device 402, such as random access memory (RAM), where the software and data for processor 401 may reside during runtime. Storage device 402 may also include non-volatile data storage. Computer system 400 may include a network interface 404 for connecting to a network. It is apparent to one of ordinary skill in the art that other known electronic components may be added or substituted in computer system 400.

Furthermore, the devices and methods described herein are generally described with respect to BBS coding system 210 and/or BBS decoding system 240 operable for BBS coding decision distribution purposes in a compressed video bitstream, such as compressed video bitstream 202. However, the systems and methods are applicable to coding and/or decoding systems for other types of coding decision distribution purposes.

Block based sampling (BBS) coding adds greater flexibility to video compression coding as compared with MPEG-4 AVC and previous MPEG standards. BBS encoding may be made more flexible by allowing blocks to be coded in a highly flexible processing order. This flexibility in BBS coding may be utilized to provide for increases in video compression coding efficiency.

While the embodiments have been described with reference to examples, those skilled in the art are able to make various modifications to the described embodiments without departing from the scope of the embodiments as described in the following claims, and their equivalents.

What is claimed is:

1. A block based sampling (BBS) encoding system to process an incoming video signal into a compressed video bitstream, the system comprising:
a processor to
determine anchor blocks in a picture from the incoming video signal, and
encode the anchor blocks in the picture.

2. The BBS encoding system of claim 1, wherein the processor is to
encode interpolated blocks in the picture using at least one of the encoded anchor blocks.

3. The BBS encoding system of claim 2, wherein the processor is to
select a pattern of the anchor blocks in the picture,
encode the anchor blocks in the pattern in the picture, wherein the encoding includes determining anchor block coding decisions, including template matching information and motion vector information from encoding the anchor blocks, and
encode interpolated blocks in the picture using at least one of the template matching information and the motion vector information associated with at least one of the anchor blocks in the pattern in the picture, wherein the interpolated block encoding includes determining coding decisions from encoding the interpolated blocks.

4. The BBS encoding system of claim 3, wherein the processor is to
identify anchor block coding decisions, and
transmit the identified anchor block coding decisions in the compressed video bitstream, wherein the transmitted anchor block coding decisions include anchor block motion vector information.

5. The BBS encoding system of claim 3, wherein the processor is to
identify interpolated block coding decisions, and
transmit the identified interpolated block coding decisions in the compressed video bitstream.

6. The BBS encoding system of claim 5, wherein the transmitted interpolated block coding decisions do not include motion vector information.

7. The BBS encoding system of claim 3, the system further comprising a storage device configured to store at least one of
the pattern of anchor blocks in the picture,
the identified anchor block coding decisions, and
the identified interpolated block coding decisions.

8. The BBS encoding system of claim 5, wherein the processor is to encode the interpolated blocks in an inter mode
wherein a motion search window and a template are determined for a partition of each interpolated block, where the template includes template matching information from at least one of the anchor blocks, and
motion vector information is determined for the partition of the interpolated block using the motion search window to identify a candidate motion vector having a nearest match with the template.

9. The BBS encoding system of claim 8, wherein the processor is to encode the inter mode coded interpolated blocks in a skip inter mode.

10. The BBS encoding system of claim 8, wherein the processor is to encode the inter mode coded interpolated blocks in an interpolative inter mode.

11. The BBS encoding system of claim 5, wherein the processor is to encode the inter mode coded interpolated blocks in an explicit inter mode and to transmit the interpolated block coding decisions including a motion vector for each interpolated block.

12. The BBS encoding system of claim 3, wherein the processor is to encode the interpolated blocks in an intra mode in which at least one of a plurality of previously encoded neighboring anchor blocks are utilized.

13. The BBS encoding system of claim 12, wherein the processor is to encode the intra mode coded interpolated blocks in an interpolative intra mode.

14. The BBS encoding system of claim 12, wherein the processor is to encode the intra mode coded interpolated blocks in an explicit intra mode.

15. The BBS encoding system of claim 3, wherein the processor is to encode the anchor blocks in one of inter mode and intra mode.

16. The BBS encoding system of claim 3, wherein the pattern in the picture provides anchor blocks spaced to produce information about neighboring anchor blocks from different directions used to encode the interpolated blocks.

17. A block based sampling (BBS) encoding method to process an incoming video signal into a compressed video bitstream, the method comprising:
determining anchor blocks in a picture from the incoming video signal; and
encoding the anchor blocks in the picture.

18. The BBS encoding method of claim 17, the method further comprising:
encoding interpolated blocks in the picture using at least one of the encoded anchor blocks.

19. The BBS encoding method of claim 18, the method further comprising:
selecting a pattern of the anchor blocks in the picture,
wherein the encoding the anchor blocks in the pattern in the picture includes determining anchor block coding decisions, including at least one of template matching information and motion vector information from encoding the anchor blocks, and
wherein the encoding interpolated blocks in the picture using at least one of the template matching information and the motion vector information associated with at least one of the anchor blocks in the pattern in the picture, wherein the interpolated block encoding includes determining coding decisions from encoding the interpolated blocks.

20. The BBS encoding method of claim 19, the method further comprising:
identifying anchor block coding decisions; and
transmitting the identified anchor block coding decisions in the compressed video bitstream, wherein the transmitted anchor block coding decisions include anchor block motion vector information.

21. The BBS encoding method of claim 19, the method further comprising:
identifying interpolated block coding decisions; and
transmitting the identified interpolated block coding decisions in the compressed video bitstream.

22. The BBS encoding method of claim 21, wherein the transmitted interpolated block coding decisions do not include motion vector information.

23. The BBS encoding method of claim 21 wherein the interpolated blocks are encoded in an inter mode,
wherein a motion search window and a template are determined for a partition of each interpolated block, where the template includes template matching information from at least one of the anchor blocks, and
motion vector information is determined for the partition of the interpolated block using the motion search window to identify a candidate motion vector having a nearest match with the template.

24. The BBS encoding method of claim 23, wherein inter mode encoded interpolated blocks are encoded in a skip inter mode.

25. The BBS encoding method of claim 23, wherein the inter mode encoded interpolated blocks are encoded in an interpolative inter mode.

26. The BBS encoding method of claim 21, wherein the inter mode coded interpolated blocks are encoded in an explicit inter mode and the transmitted interpolated block coding decisions including a motion vector for each interpolated block.

27. The BBS encoding method of claim 19, wherein the interpolated blocks are encoded in an intra mode in which at least one of a plurality of previously encoded neighboring anchor blocks are utilized.

28. The BBS encoding method of claim 27, wherein the intra mode encoded interpolated blocks are encoded in an interpolative intra mode.

29. The BBS encoding method of claim 27, wherein the intra mode coded interpolated blocks are encoded in an explicit intra mode.

30. The BBS encoding method of claim 18, wherein the anchor blocks are encoded in one of inter mode and intra mode.

31. The BBS encoding method of claim 19, wherein the pattern in the picture provides anchor blocks spaced to produce information about neighboring anchor blocks from different directions used to encode the interpolated blocks.

32. A non-transitory computer readable medium storing computer readable instructions that when executed by a computer system perform a block based sampling (BBS) encoding method to process an incoming video signal into a compressed video bitstream, the method comprising:
determining anchor blocks in a picture from the incoming video signal; and
encoding the anchor blocks in the picture.

33. The computer readable medium of claim 32, the method further comprising:
encoding interpolated blocks in the picture using at least one of the encoded anchor blocks.

34. A block based sampling (BBS) decoding system to decode pictures from an incoming compressed video bitstream, the BBS decoding system comprising:
a processor to
receive the incoming compressed video bitstream including anchor block coding decisions about anchor blocks in a pattern in a picture, and
decode the received anchor block coding decisions to form the anchor blocks in the pattern in the picture.

35. The BBS decoding system of claim 34, wherein the processor is to
receive the incoming compressed video bitstream including interpolated block coding decisions about interpolated blocks in the picture encoded using at least one of the anchor blocks, and
decode the received interpolated block coding decisions to form interpolated blocks in the picture associated with the anchor blocks in the pattern.

36. The BBS decoding system of claim 34, the system further comprising
a storage device configured to store at least one of
the pattern of anchor blocks in the picture,
the anchor block coding decisions, and
the interpolated block coding decisions.

37. The BBS decoding system of claim 35, wherein the processor is to decode the interpolated blocks coded in an inter mode utilizing template matching information for each interpolated block including a motion search window and an interpolated block template,
wherein interpolated block motion vector information is determined for each interpolated block using the motion search window to determine a candidate motion vector having a nearest match with the interpolated block template.

38. The BBS decoding system of claim 34, wherein the processor is to decode the anchor blocks coded in one of inter mode and intra mode.

39. The BBS decoding system of claim 34, wherein the pattern in the picture provides anchor blocks spaced to produce information about neighboring anchor blocks from different directions to code interpolated blocks.

40. A block based sampling (BBS) decoding method to decode pictures from an incoming compressed video bitstream, the method comprising:
receiving the incoming compressed video bitstream including anchor block coding decisions about coded anchor blocks in a pattern in a picture; and
decoding the received anchor block coding decisions to form the anchor blocks in the pattern in the picture.

41. The BBS decoding method claim 40, the method further comprising:
receiving the incoming compressed video bitstream including interpolated block coding decisions about interpolated blocks in the picture coded in a second pass using at least one of the anchor blocks; and
decoding the received interpolated block coding decisions to form interpolated blocks in the picture associated with the anchor blocks in the pattern.

42. The BBS decoding method of claim 41, wherein the interpolated blocks are coded in an inter mode utilizing template matching information for each interpolated block including a motion search window and an interpolated block template,
wherein interpolated block motion vector information is determined for each interpolated block using the motion search window to determine a candidate motion vector having a nearest match with the interpolated block template.

43. The BBS decoding method of claim 40, wherein the anchor blocks are coded in one of inter mode and intra mode.

44. The BBS decoding method of claim 40, wherein the pattern in the picture provides anchor blocks are spaced to produce information about neighboring anchor blocks from different directions to code interpolated blocks.

45. A non-transitory computer readable medium storing computer readable instructions that when executed by a computer system perform a block based sampling (BBS) decoding method to decode pictures from an incoming compressed video bitstream, the BBS decoding method comprising:
receiving the incoming compressed video bitstream including anchor block coding decisions about coded anchor blocks in a pattern in a picture; and
decoding the received anchor block coding decisions to form the anchor blocks in the pattern in the picture.

46. The computer readable medium of claim 45, the BBS decoding method further comprising:
receiving the incoming compressed video bitstream including interpolated block coding decisions about interpolated blocks in the picture coded in a second pass using at least one of the anchor blocks; and
decoding the received interpolated block coding decisions to form interpolated blocks in the picture associated with the anchor blocks in the pattern.

47. The computer readable medium of claim 46, wherein the interpolated blocks are coded in an inter mode utilizing template matching information for each interpolated block including a motion search window and an interpolated block template,
wherein interpolated block motion vector information is determined for each interpolated block using the motion search window to determine a candidate motion vector having a nearest match with the interpolated block template.

48. The computer readable medium of claim 47, wherein the pattern in the picture provides anchor blocks spaced to produce information about neighboring anchor blocks from different directions to code interpolated blocks.
